(19) United States
(12) Patent Application Publication
(10) Pub. No.: US 2026/0338203 A1
(43) Pub. Date: Oct. 29, 2026

(54) FLUID PRESSURE CIRCUIT

(71) Applicant: EAGLE INDUSTRY CO., LTD., Tokyo (JP)

(72) Inventors: Yuichi ISHII, Tokyo (JP); Koji SATO, Tokyo (JP)

(21) Appl. No.: 19/107,463

(22) PCT Filed: Nov. 13, 2023
(86) PCT No.: PCT/JP2023/040691

§ 371 Date: Feb. 27, 2025

(30) Foreign Application Priority Data
Nov. 25, 2022 (JP) 2022-188124

(51) Int. Cl. F15B 11/024; E02F 9/22

(52) U.S. Cl. CPC F15B 11/024; E02F 9/2203; E02F 9/2217; E02F 9/2285; E02F 9/2292

(57) ABSTRACT

There is provided a fluid pressure circuit in which a change in rod speed is small even during regeneration. A fluid pressure circuit includes a cylinder device, an operation switching valve, and a regenerative circuit that branches off from a flow passage between the cylinder device and the operation switching valve via a flow diverter valve. A detection device that detects discharge information is disposed between the cylinder device and the flow diverter valve. The flow diverter valve is controlled based on the discharge information detected by the detection device and information obtained from the regenerative circuit.

### TECHNICAL FIELD

The present invention relates to a fluid pressure circuit, for example, a fluid pressure circuit that controls the rod stroke of a cylinder device in response to operation commands.

### BACKGROUND ART

Generally, a fluid pressure circuit that controls the rod stroke of a cylinder device in response to an operation command is used in work machines, construction machines, cargo handling vehicles, automobiles, and the like. In the fluid pressure circuit, there is a demand for energy saving, and a fluid discharged from the cylinder device can be regenerated to effectively utilize energy.

As such a fluid pressure circuit, for example, a hydraulic circuit 152 illustrated in FIG. 7 is known. In the hydraulic circuit 152, when an operating lever 112a of a remote control valve 112 is operated in an extension direction A, a flow control valve 104 is switched to an extension position. Pressure oil from a hydraulic pump 102 is introduced into a bottom chamber 105-1 of a cylinder device 105. A rod 105a extends toward the outside. Meanwhile, in the hydraulic circuit 152, when the operating lever 112a is operated in a retraction direction B, the flow control valve 104 is switched to a retraction position. The pressure oil from the hydraulic pump 102 is introduced into a rod chamber 105-2. The rod 105a retracts into the inside of the cylinder device 105.

Further, a branch oil passage 130 is branched off and connected to an oil passage 124 connecting the bottom chamber 105-1 and the flow control valve 104. By opening a regenerative variable switching valve 109, a part of the return oil discharged from the bottom chamber 105-1 is discharged into a tank 108 through a branch oil passage 130 (Patent Citation 1). The branch oil passage 130 constitutes a regenerative circuit, together with a hydraulic motor 110. The regenerative circuit can drive a generator 111, which is connected to the hydraulic motor 110, to recover the energy of a part of the return oil as electrical energy.

### CITATION LIST

### Patent Literature

Patent Citation 1: JP 2014-29180 A (Page 6, FIG. 1)

### SUMMARY OF INVENTION

### Technical Problem

In such a fluid pressure circuit, a variable throttle As is provided in a flow passage connecting the oil passage 124 and an oil passage 126 of the flow control valve 104. By restricting the flow rate using the variable throttle As, the fluid pressure circuit is allowed to control the actuation speed of the rod 105a of the cylinder device 105 in response to the operation amount of the operating lever 112a of the remote control valve 112. In addition, a load W of a payload or the like acts on the cylinder device 105 in the direction of gravity. The load W varies depending on the payload. The fluid pressure circuit adjusts the variable throttle As such that the rod retraction speed does not vary greatly due to a difference in the load W. Accordingly, the fluid pressure circuit is designed to keep discharge pressure between the cylinder device 105 and the flow control valve 104 within an appropriate range. However, in the fluid pressure circuit, since the return fluid is branched off during regeneration such as electricity storage or pressure storage, the total flow passage length for the fluid changes from during non-regeneration, and the value of pressure loss changes. Accordingly, even when the operation amount by a worker is the same, a difference in the actuation speed of the rod occurs between regeneration and non-regeneration, so that the worker feels a discrepancy in operational feel. In addition, during regeneration, switching is performed between a regenerative state and a non-regenerative state based on the electricity storage amount of the regenerative circuit. When a relatively large load W is applied during the switching, the flow passage resistance of the circuit changes suddenly, and accordingly, the discharge pressure between the cylinder device 105 and the flow control valve 104 may deviate greatly from an appropriate range. In such a situation, the rod of the cylinder device that is controlled in response to an operation command cannot be smoothly controlled.

The present invention has been made to solve the above-described problems, and an object of the present invention is to provide a fluid pressure circuit in which a change in rod speed is small even during regeneration.

### Solution to Problem

In order to solve the foregoing problems, a fluid pressure circuit according to the present invention is a fluid pressure circuit including: a cylinder device; an operation switching valve; and a regenerative circuit that branches off from a flow passage between the cylinder device and the operation switching valve via a flow diverter valve, wherein a detection device that detects discharge information is disposed between the cylinder device and the flow diverter valve, and the flow diverter valve is controlled based on the discharge information detected by the detection device and information obtained from the regenerative circuit. According to the aforesaid feature of the present invention, by controlling the flow rate of a return fluid discharged from the cylinder device to the regenerative circuit, based on the discharge information of the cylinder device detected by the detection device, namely, a difference in a load applied to the cylinder device, the rod speed when a fluid flows to the regenerative circuit can be made the same as the rod retraction speed when the fluid does not flow, so that any discrepancy in the operational feel of a worker can be prevented.

It may be preferable that the regenerative circuit includes a storage device, and the flow diverter valve is controlled based on a signal from a storage detection device that detects a storage state of the storage device, and on the discharge information from the detection device. According to this preferable configuration, when switching is performed between regeneration and non-regeneration of the storage device, driving can be performed to suppress a change in the rod speed of the cylinder device.

It may be preferable that a first throttle provided in the flow passage between the cylinder device and the operation switching valve and a second throttle provided in the flow diverter valve are controlled by functions with different positive and negative slopes. According to this preferable configuration, since the total throttle amount achieved by the first throttle and the second throttle do not change, the rod speed can be easily controlled according to the load applied to the cylinder device. In addition, by controlling the first throttle and the second throttle, composite opening characteristics during regeneration and during non-regeneration can be made closer to each other.

It may be preferable that the flow diverter valve is a 3-port, 2-position electromagnetic proportional throttle valve of normal-open type that simultaneously controls opening degrees of the first throttle and the second throttle. According to this preferable configuration, the opening degree of the second throttle increases or decreases in proportion to an increase or a decrease in the opening degree of the first throttle, so that the total throttle amount achieved by the first throttle and the second throttle can be made unchanged, and with a simple structure, the rod speed can be controlled according to the load applied to the cylinder device.

### BRIEF DESCRIPTION OF DRAWINGS

FIG. 1 is a view illustrating a wheel loader incorporating a fluid pressure circuit according to a first embodiment of the present invention.

FIG. 2 is a view illustrating the fluid pressure circuit in the first embodiment.

FIG. 3 is a graph illustrating a relationship between an operating lever stroke and a pilot secondary pressure in the first embodiment.

FIG. 4 is a graph illustrating a relationship between an input current from a controller and an opening degree in the first embodiment.

FIG. 5 is a graph illustrating a relationship between the operating lever stroke and an opening area in the first embodiment, FIG. 5A illustrates when regeneration is activated, and FIG. 5B illustrates when regeneration is not activated.

FIG. 6 is a view illustrating a fluid pressure circuit according to a second embodiment of the present invention.

FIG. 7 is a view illustrating a conventional fluid pressure circuit.

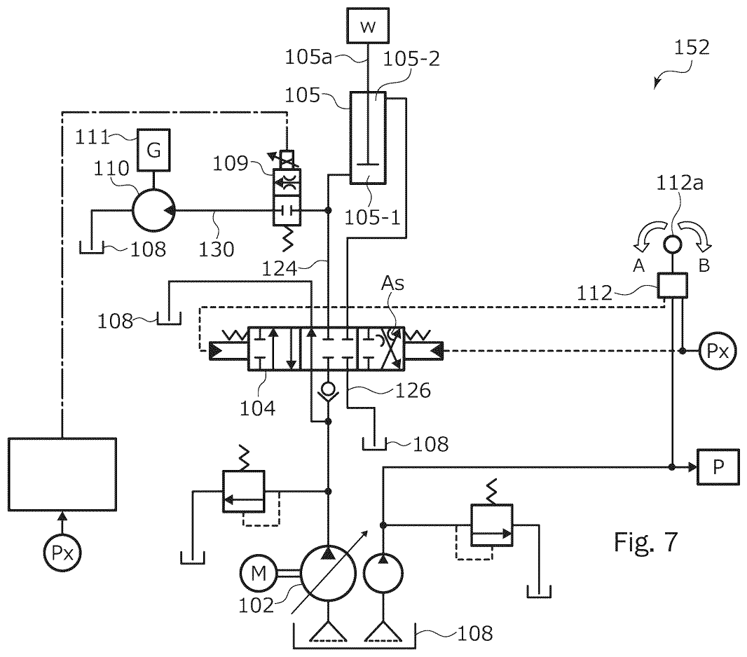

### DESCRIPTION OF EMBODIMENTS

Modes for implementing a fluid pressure circuit according to the present invention will be described below based on embodiments.

### First Embodiment

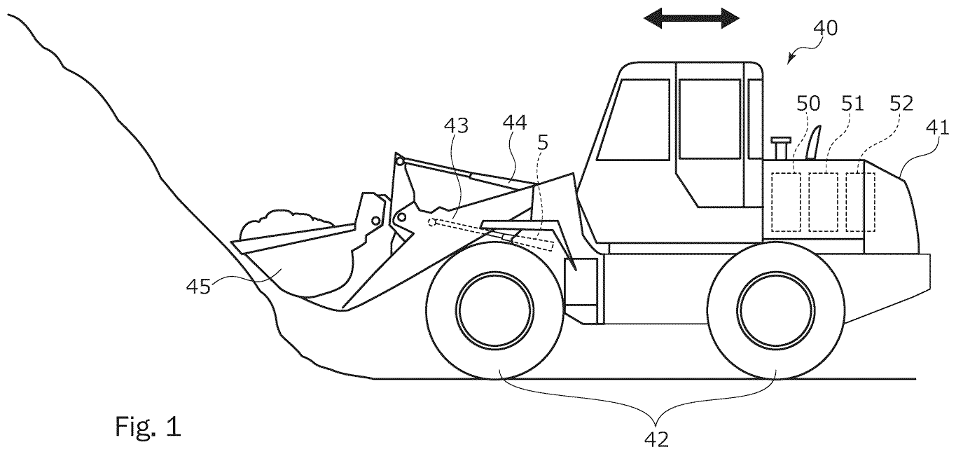

A fluid pressure circuit according to a first embodiment of the present invention will be described with reference to FIGS. 1 to 5.

A hydraulic circuit as the fluid pressure circuit according to the first embodiment is a hydraulic circuit that controls the stroke of a cylinder device in response to an operation command in a work machine, a construction machine, a cargo handling vehicle, an automobile, or the like. Preferably, the hydraulic circuit is used in a circuit in which the load of a payload is heavier compared to the load of a work arm itself, and is incorporated into, for example, a power train of a wheel loader 40 illustrated in FIG. 1. The wheel loader 40 is mainly composed of a vehicle body 41; traveling wheels 42; a work arm 43; a hydraulic cylinder 44; and a bucket 45 for taking in gravel and the like. A machine 50 such as an engine, a traveling fluid circuit 51, and a work hydraulic circuit 52 that drives a hydraulic cylinder 5 serving as a cylinder device and the like are provided on the vehicle body 41.

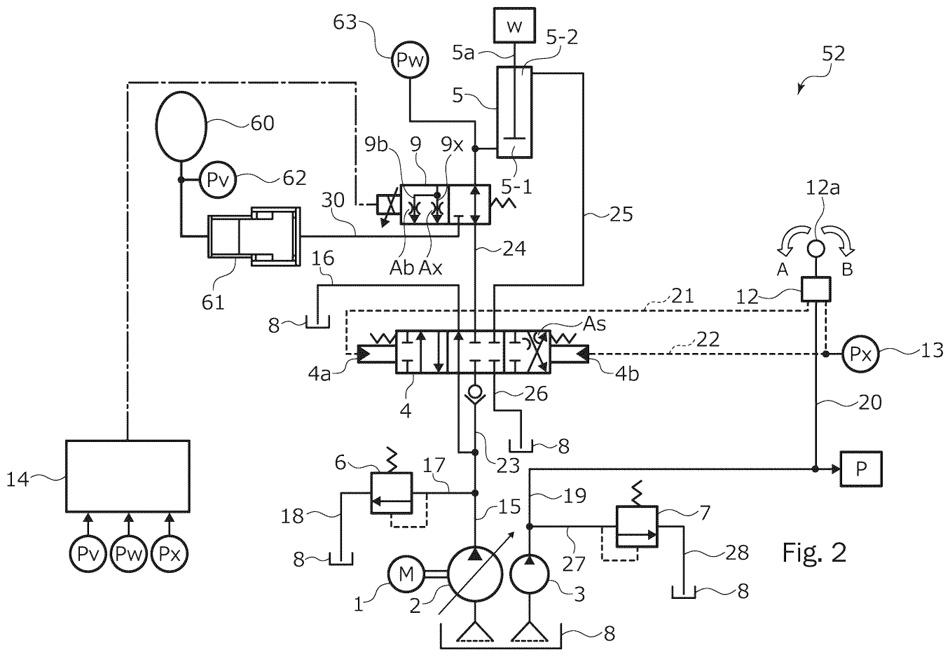

As illustrated in FIG. 2, the hydraulic circuit 52 includes a main hydraulic pump 2 that is a fluid pressure actuator driven by a drive mechanism 1 such as an engine or an electric motor; a pilot hydraulic pump 3; a flow control valve 4 that is an operation switching valve; the hydraulic cylinder 5 that is a cylinder device; relief valves 6 and 7; a tank 8; an accumulator 60 that is a storage device; a pressure booster 61; a remote control valve 12; a pressure sensor 13; a controller 14; and oil passages 15 to 28 and 30. The accumulator 60 and the pressure booster 61 constitute a regenerative circuit of the present invention.

The main hydraulic pump 2 is coupled to the drive mechanism 1 such as an internal combustion engine, and is rotated by power from the drive mechanism 1 to supply pressure oil to a downstream side through the oil passage 15.

The pressure oil discharged from the main hydraulic pump 2 flows into the flow control valve 4 through the oil passage 15. The flow control valve 4 is a 6-port, 3-position open center switching valve. When a spool is in a neutral position, the entire amount of the pressure oil discharged from the main hydraulic pump 2 flows to the tank 8 through the oil passage 16.

In a main circuit including the main hydraulic pump 2, the relief valve 6 for preventing damage to hydraulic devices in the circuit is installed. The relief valve 6 opens if the oil pressure in the circuit becomes abnormally high when a rod 5a of the hydraulic cylinder 5 reaches an extension terminal end or a retraction terminal end or when a sudden load is applied to the hydraulic cylinder 5. Accordingly, the relief valve 6 can discharge the high-pressure oil to the tank 8 through the oil passages 17 and 18.

Similarly to the main hydraulic pump 2, the pilot hydraulic pump 3 is coupled to the drive mechanism 1, and is rotated by power from the drive mechanism 1 to supply the pressure oil to the downstream side through the oil passage 19. Here, a part of the pressure oil supplied to the downstream side through the oil passage 19 is supplied to the remote control valve 12 through the oil passage 20.

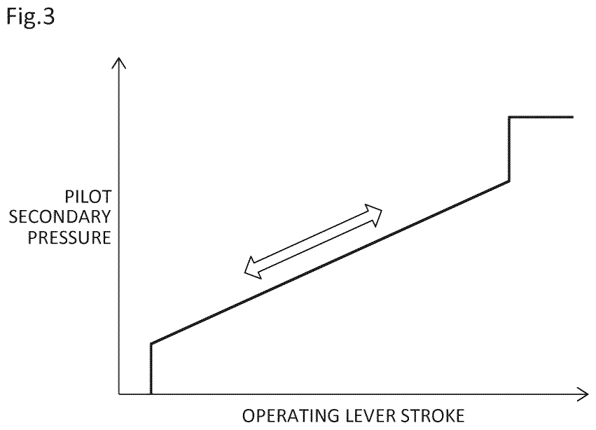

The remote control valve 12 is a variable pressure-reducing valve, and serves to control the extension position or the retraction position, namely, the extension amount or the retraction amount, of the rod 5a. The remote control valve 12 can output a pilot secondary pressure proportional to the operating lever stroke of an operating lever 12a illustrated in FIG. 3. When the operating lever 12a is operated in an extension direction A or a retraction direction B of the rod 5a of the hydraulic cylinder 5, the remote control valve 12 supplies the pilot secondary pressure to a signal port 4a or a signal port 4b of the flow control valve 4 through the signal oil passage 21 or the signal oil passage 22. Incidentally, the operation amount of the operating lever 12a is substantially equivalent to the stroke of the operating lever 12a, and is referred to as an operating lever stroke.

When the operating lever 12a of the remote control valve 12 is operated in the extension direction A and the flow control valve 4 is switched to an extension position, the pressure oil from the main hydraulic pump 2 flows into a bottom chamber 5-1 of the hydraulic cylinder 5 through the oil passage 23 and the oil passage 24. The oil in a rod chamber 5-2 passes through the oil passage 25, then through the oil passage 26 via the flow control valve 4, and is discharged into the tank 8. Accordingly, the rod 5a of the hydraulic cylinder 5 actuates in the extension direction.

Meanwhile, when the operating lever 12a of the remote control valve 12 is operated in the retraction direction B and the flow control valve 4 is switched to the retraction position, the pressure oil from the main hydraulic pump 2 flows into the rod chamber 5-2 of the hydraulic cylinder 5 through the oil passage 23 and the oil passage 25. The oil in the bottom chamber 5-1 passes through the oil passage 24, then through the oil passage 26 via the flow control valve 4, and is discharged into the tank 8. Accordingly, the rod 5a of the hydraulic cylinder 5 actuates in the retraction direction.

As illustrated in FIG. 3, the remote control valve 12 outputs the pilot secondary pressure that increases in proportion to an increase in the operating lever stroke of the operating lever 12a of the remote control valve 12. The flow control valve 4 is configured such that the spool strokes substantially in proportion to the pilot secondary pressure of the remote control valve 12, and has an opening characteristic in which the opening amount of the flow control valve 4 increases according to the spool stroke. When the amount of the pressure oil supplied to the hydraulic cylinder 5 increases with an increase in the opening amount of the flow control valve 4, the hydraulic cylinder 5 is configured to increase the actuation speed of the rod 5a. Namely, the rod speed can be controlled according to the operating lever stroke of the operating lever 12a of the remote control valve 12.

Incidentally, when a load W acts on the hydraulic cylinder 5 in the direction of gravity as illustrated in FIG. 2, the rod speed is predominantly controlled by a C-T opening that is an opening from the hydraulic cylinder 5 to a tank 8 side. A variable throttle As that is a third throttle is provided in a flow passage connecting the oil passage 24 and the oil passage 26 of the flow control valve 4. By restricting the flow rate using the variable throttle As, the actuation speed of the rod 5a due to the load W can be slowed down.

In addition, in a pilot circuit including the pilot hydraulic pump 3, the relief valve 7 for controlling the maximum pressure in the circuit is installed. The relief valve 7 is opened when the lever of the remote control valve 12 is in a neutral position, so that the pressure oil can be discharged into the tank 8 through the oil passage 27 and the oil passage 28.

A regenerative variable switching valve 9 serving as a flow diverter valve is provided in the oil passage 24. The regenerative variable switching valve 9 is a 3-port, 2-position normally open electromagnetic proportional throttle valve. The regenerative variable switching valve 9 allows the entire amount of return oil from the bottom chamber 5-1 of the hydraulic cylinder 5 to pass therethrough when in a neutral position as during non-regeneration. The entire amount of the return oil passes through the oil passage 24, then through the oil passage 26 via the flow control valve 4, and is discharged into the tank 8.

The regenerative variable switching valve 9 includes a flow passage 9x that is connected to the oil passage 24 as a function of a switched position that is a regeneration position, and a flow passage 9b branching off from the oil passage 24 and connected to the oil passage 30. A variable throttle Ab that is a first throttle is provided in the flow passage 9b connected to the oil passage 30. A variable throttle Ax that is a second throttle is provided in the flow passage 9x connected to the oil passage 24.

When the regenerative variable switching valve 9 is switched from the neutral position to a position where the oil passage 24 and the oil passage 30 branch off from each other, a part of the return oil from inside the bottom chamber 5-1 of the hydraulic cylinder 5 is restricted in flow rate by the variable throttle Ab and flows into the oil passage 30. The remaining return oil is restricted in flow rate by the variable throttle Ax, is further restricted by the variable throttle As of the flow control valve 4 located downstream, and is discharged into the tank 8.

In addition, the pressure sensor 13 is installed on the signal oil passage 22. The pressure sensor 13 outputs an electric signal to the controller 14 when the operating lever 12a of the remote control valve 12 is operated in the retraction direction B and the pilot secondary pressure is generated in the signal oil passage 22. The controller 14 can output an electric signal to the regenerative variable switching valve 9 from an arithmetic circuit incorporated in advance. The controller 14 outputs an electric signal to the regenerative variable switching valve 9 when an electric signal is input from the pressure sensor 13 and an storage detector 62 to be described later detects a situation where pressure needs to be stored in the accumulator 60, namely, an allowable pressure storage amount is not reached. When the electric signal is input from the controller 14, the regenerative variable switching valve 9 is switched to the position where the oil passage 24 and the oil passage 30 branch off from each other. A part of the return oil flows into an accumulator 60 side.

As illustrated in FIG. 2, the pressure booster 61 is disposed upstream of the accumulator 60. The pressure booster 61 is connected to the oil passage 30. In addition, the storage detector 62 that detects a storage state is disposed in an inlet pipe of the accumulator 60. Although not described in detail here, regenerative energy stored in the accumulator 60 is supplied to the hydraulic cylinder 5 when necessary, and is appropriately utilized.

In addition, a pressure sensor 63 that is a detection device is installed in a pipe on a bottom chamber 5-1 side of the hydraulic cylinder 5. The pressure sensor 63 is connected to the controller 14. The pressure sensor 63 can transmit detected discharge information on the bottom chamber 5-1 side of the hydraulic cylinder 5, in other words, on the secondary, to the controller 14. Incidentally, it is preferable that the detection device not only detects pressure, but also detects the degree of discharge such as flow rate or flow speed, namely, a difference in discharge conditions due to a difference in the weight of the load W.

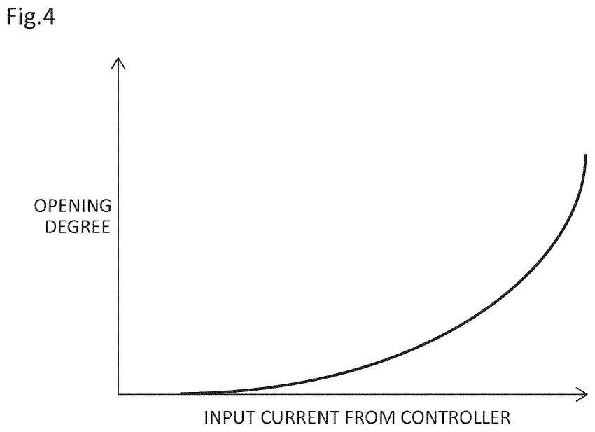

FIG. 4 is a graph illustrating a relationship between an input current from the controller 14 and an opening degree of the variable throttle As of the flow control valve 4. As illustrated in FIG. 4, the opening degree of the variable throttle As increases or decreases in proportion to the input current from the controller 14. The input current increases or decreases in proportion to the operation amount of the operating lever 12a in the retraction direction B. When the operating lever 12a is operated in the retraction direction B during non-regeneration, the controller 14 can variably control the opening degree of the variable throttle As according to the operation amount of the operating lever 12a.

As described above, when the load W acts on the hydraulic cylinder 5 in the direction of gravity, the rod speed of the hydraulic cylinder 5 during non-regeneration is predominantly controlled by the C-T opening that is the opening from the hydraulic cylinder 5 to the tank 8 side. Meanwhile, when the regenerative variable switching valve 9 is switched to the regeneration position where the oil passage 24 and the oil passage 30 branch off from each other, the throttle opening degree of the variable throttle Ab and the throttle opening degree of the variable throttle Ax of the regenerative variable switching valve 9 also play a great role in controlling the rod speed of the cylinder. Namely, when the regenerative variable switching valve 9 is switched, the rod speed is predominantly controlled by a composite opening characteristic formed by an opening characteristic of the flow control valve 4 and an opening characteristic of the regenerative variable switching valve 9.

In addition, the pressure storage amount of the accumulator 60 is detected by the storage detector 62. The controller 14 monitors information on the pressure storage amount transmitted from the storage detector 62. When it is determined that the accumulator 60 has reached the allowable pressure storage amount, the controller 14 stops outputting the electric signal to the regenerative variable switching valve 9. Due to the stop of the electric signal, the regenerative variable switching valve 9 returns to the neutral position, and the flow passage connected to the oil passage 30 is closed. Accordingly, the amount of inflow to the accumulator 60 is cut off, so that the regenerative circuit is set to a non-regenerative state. Then, the return oil of the cylinder is discharged into the tank 8 only via the variable throttle As of the flow control valve 4.

As described above, in the hydraulic circuit 52 of the present embodiment, the regenerative variable switching valve 9 includes the flow passage 9b and the flow passage 9x. The flow passage 9b includes the variable throttle Ab, and is connected to the oil passage 30 during regeneration. The flow passage 9x includes the variable throttle Ax, and is connected to the oil passage 24 during regeneration. The variable throttle Ax is connected in series with the variable throttle As through the oil passage 24 during regeneration. During regeneration, a part of the return oil is branched off to oil passage 30. The flow rate of the remaining return oil is limited by the variable throttle Ax and the variable throttle As.

The following relational expression is established for the opening characteristic of each of the variable throttle Ab, the variable throttle Ax, and the variable throttle As.

First, since the variable throttle Ax and the variable throttle As are disposed in series, the equation for a composite throttle Ac is expressed as the following Equation (1).

Composite throttle: Ac=Ax·As/√(Ax2+As2) Equation (1)

In addition, if an equivalent throttle of the regenerative variable switching valve 9 and the flow control valve 4 on a C-T line of the cylinder is At, when the regenerative variable switching valve 9 is in the neutral position (during non-regenerative), the equivalent throttle is expressed by the following Equation (2).

At=Ac+As Equation (2)

When the regenerative variable switching valve 9 is switched (namely, during regeneration), the equivalent throttle is expressed by the following Equation (3).

At=Ac+Ab Equation (3)

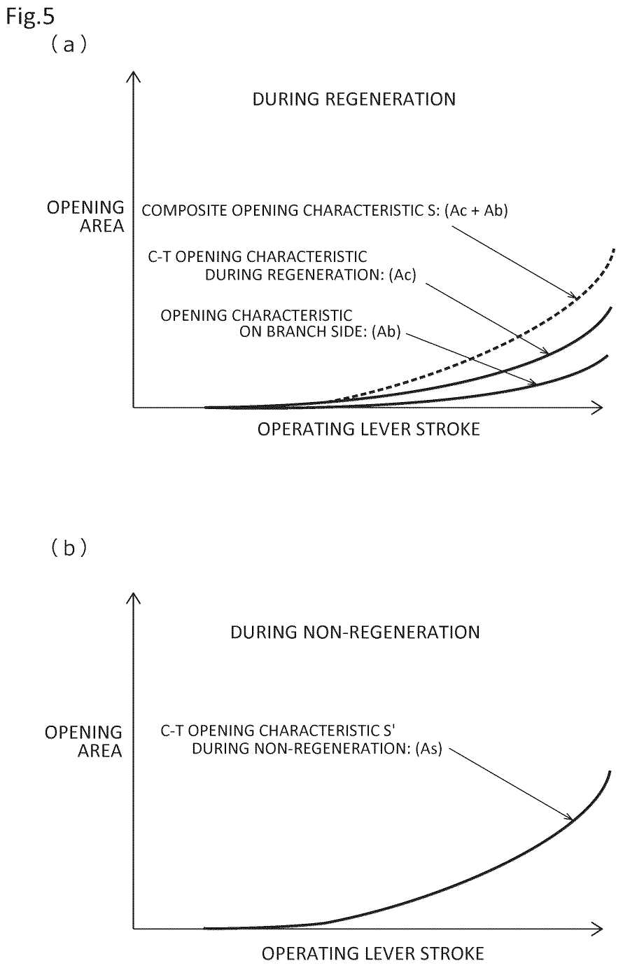

Due to the above-described relationship, by setting Ax, the equivalent throttle At described above can be made equal even when the regenerative variable switching valve 9 is in the neutral position or in the position where the oil passage 24 and the oil passage 30 branch off from each other. Namely, by setting Ax, as illustrated in FIGS. 5A and 5B, an opening characteristic (Ac+Ab) of a composite opening characteristic curve S formed by a C-T opening characteristic (Ac) during regeneration and an opening characteristic (Ab) of the branch side of the regenerative variable switching valve 9, and an opening characteristic (As) of an opening characteristic curve S′ during non-regeneration can be always kept constant.

Namely, based on Equation (2) and Equation (3), Ax is set such that the following Equation (4) is established.

As=Ac+Ab Equation (4)

Therefore, the following Equation (5) is derived from Equation (1) and Equation (4).

Ax=As·(As−Ab)/√(Ab·(2×As−Ab)) Equation (5)

Accordingly, the composite opening characteristic curve S during regeneration and the opening characteristic curve S′ during non-regeneration can be made substantially equal, and the rod 5a can be smoothly controlled.

When the return oil is branched off and supplied to the pressure booster 61, the opening characteristic during regeneration in which the variable throttle Ax and the variable throttle Ab are located in parallel and the variable throttle Ax and the variable throttle As are located in series is set. Namely, the opening characteristic during regeneration in which the flow rate of the return oil passing through the oil passage 24 is limited is set. When the regenerative variable switching valve 9 is switched from the regeneration position to a non-regeneration position, the opening characteristic is switched from the opening characteristic during regeneration in which the variable throttle Ax and the variable throttle As are located in series to the opening characteristic during non-regeneration in which the flow rate is limited by the variable throttle As. As described above, by setting the composite opening characteristic curve S during regeneration and the opening characteristic curve S′ during non-regeneration to be substantially equal, the difference between the opening characteristic during regeneration and the opening characteristic during non-regeneration can be reduced. Therefore, a sudden change in the rod speed of the hydraulic cylinder 5 can be suppressed, and the rod 5a can be smoothly controlled.

As described above, the controller 14 constantly monitors the numerical value of the discharge pressure of the hydraulic cylinder 5 detected by the pressure sensor 63 during regeneration. The controller 14 compares the discharge pressure actually detected by the pressure sensor 63 with a reference value of the discharge pressure corresponding to the operation amount of the operating lever 12a in the retraction direction B to calculate difference information therebetween.

Then, when the controller 14 controls the opening degrees of the variable throttle Ax and the variable throttle Ab, the controller 14 controls the input current to the regenerative variable switching valve 9 by adding or subtracting the difference information as a correction value. For example, when the numerical value of the discharge pressure on the secondary side detected by the pressure sensor 63 is higher than the reference value, namely, when the load W is larger than a reference value, control is performed to reduce the opening degree of the variable throttle Ab.

In such a manner, when the load W is larger than the reference value, the controller 14 performs control to reduce the opening of the variable throttle Ab and to relatively open the variable throttle Ax. Accordingly, the fluid pressure circuit is designed to adjust the variable throttle As such that the rod retraction speed of the hydraulic cylinder 5 in response to the operation amount of the operating lever 12a of the remote control valve 12 is prevented from varying greatly due to a difference in the load W, and to keep the discharge pressure between the hydraulic cylinder 5 and the flow control valve 4 within an appropriate range. As described above, by controlling the opening degrees of the variable throttle Ab and the variable throttle Ax according to the load W applied to the hydraulic cylinder 5, the discharge pressure between the hydraulic cylinder 5 and the flow control valve 4 can be kept within an appropriate range, and the rod 5a of the hydraulic cylinder 5 that is controlled in response to an operation command can be smoothly controlled.

Subsequently, it is preferable that the following relationship is satisfied:

Pressure loss due to As when the fluid does not flow through the regenerative circuit (namely, during non-regeneration or during non-pressure storage)=pressure loss due to a composite resistance of Ax and As when the fluid flows through the regenerative circuit (namely, during regeneration or during pressure storage)+pressure loss due to Ab when the fluid flows through the regenerative circuit (namely, during regeneration or during pressure storage)+pressure loss in the regenerative circuit.

In addition, as described above, when it is determined that the pressure storage amount of the accumulator 60 detected by the storage detector 62 has reached the allowable pressure storage amount, the controller 14 causes the regenerative variable switching valve 9 to return to the neutral position. Namely, the controller 14 performs switching to a non-regenerative state where the flow passage connected to the oil passage 30 is closed to cut off the amount of inflow to the accumulator 60 side. Before switching to the non-regenerative state, the controller 14 may perform control to reduce the opening of the variable throttle Ab, which is provided in the flow passage 9b of the regenerative variable switching valve 9, according to a difference between the pressure storage amount and the allowable pressure storage amount. This control is performed when the load W is larger than the reference value and when the difference between the pressure storage amount of the accumulator 60 detected by the storage detector 62 and the allowable pressure storage amount is smaller than a predetermined value set in advance, namely, when the pressure storage amount is close to the allowable pressure storage amount. Accordingly, a sudden change in the opening amount of the variable throttle Ab when switching is performed from regeneration to non-regeneration can be suppressed, and the rod 5a can be smoothly controlled.

In addition, the controller 14 may perform control to open the opening of the variable throttle Ab according to the difference between the pressure storage amount and the allowable pressure storage amount. This control may be performed when the load W is larger than the reference value and when the difference between the pressure storage amount detected by the storage detector 62 and the allowable pressure storage amount is larger than the predetermined value set in advance.

In addition, the regenerative variable switching valve 9 is a 3-port, 2-position normally open electromagnetic proportional throttle valve. The opening degrees of the variable throttle Ab and the variable throttle Ax are controlled simultaneously. Namely, when control is performed to open the opening degree of the variable throttle Ab, the opening degree of the variable throttle Ax is reduced. In other words, it can be said that when the change in the throttle amount of the variable throttle Ab indicates a linear function, the throttle amount of the variable throttle Ax is controlled to be inversely proportional. Accordingly, with a simple structure, the speed of the rod 5a can be accurately controlled according to the load applied to the hydraulic cylinder 5.

### Second Embodiment

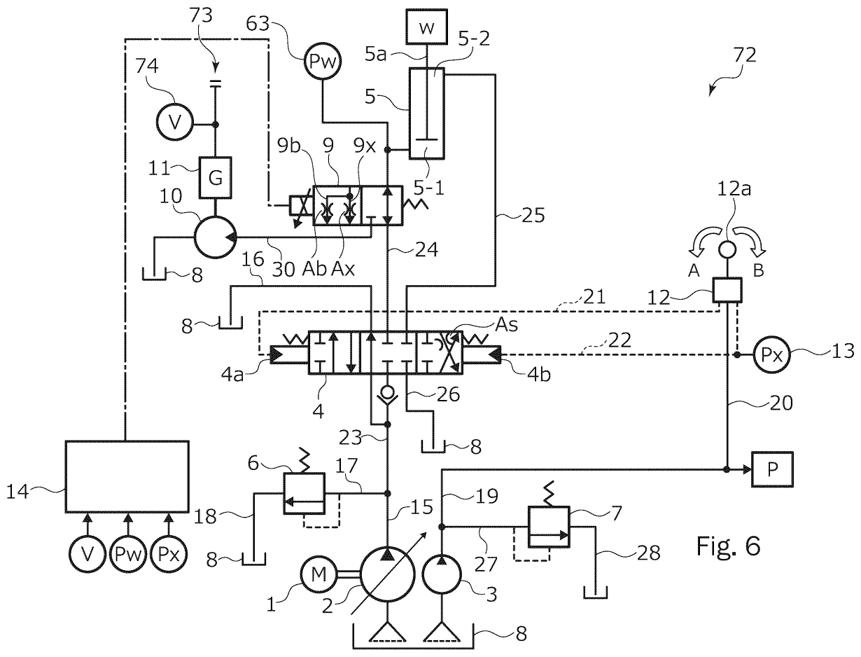

Next, a hydraulic circuit 72 according to a second embodiment of the present invention will be described with reference to FIG. 6. Incidentally, the description of configurations that are the same as and overlap with the configurations of the first embodiment will be omitted.

Namely, since the relationship between the opening characteristics is also the same, the description thereof will be omitted.

In the hydraulic circuit 72 of FIG. 6, a regenerative circuit is provided with a regenerative motor 10, a generator 11, and an electricity storage device 73 such as a capacitor. In the hydraulic circuit 72, when the regenerative variable switching valve 9 is switched, a part of the return oil passes through the oil passage 30 via the regenerative variable switching valve 9 and flows into the regenerative motor 10. Accordingly, the regenerative motor 10 rotates and the generator 11 generates electricity. The electricity storage device 73 includes a storage detector 74 capable of detecting the electricity storage amount of the electricity storage device 73 and transmitting the detection result to the controller 14. For example, when the electricity storage device 73 is a capacitor, the storage detector 74 is a voltage detector or the like.

When it is determined that the electricity storage amount of the electricity storage device 73 has reached an allowable electricity storage amount, based on a signal from the storage detector 74, the controller 14 stops outputting the electric signal to the regenerative variable switching valve 9.

The embodiments of the present invention have been described above with reference to the drawings; however, specific configurations are not limited to these embodiments, and modifications or additions that are made without departing from the scope of the present invention are also included in the present invention.

For example, in the above-described embodiments, a configuration in which the controller 14 adjusts the opening degree of the variable throttle Ax based on a signal indicating the storage state detected by the storage detector 62 (74) and the discharge information from the pressure sensor 63, and controls the flow rate of the return oil discharged to the regenerative circuit has been described; however, the present invention is not limited thereto, and for example, even when the regenerative circuit does not include the storage device and regenerative energy is directly utilized, the opening degree of the variable throttle Ax may be adjusted based on demand information of the return oil from a regenerative circuit side and the discharge information from the pressure sensor 63.

In addition, a configuration in which a regenerative variable switching valve including the variable throttle Ab and a regenerative variable switching valve including the variable throttle Ax are independently provided on the oil passage 24, the regenerative variable switching valves are connected to each other by a separate oil passage, each of the regenerative variable switching valves is connected to the controller 14, and the operation of each of the regenerative variable switching valves is controlled may be employed.

In addition, in the above-described embodiments, a configuration in which the variable throttle Ax located in series with the variable throttle As of the flow control valve 4 is provided has been described; however, the present invention is not limited thereto, and for example, when switching is performed from a regenerative state to a non-regenerative state, the controller 14 is configured to be able to adjust the variable throttle As of the flow control valve 4 during regeneration such that the composite opening characteristic formed by the opening characteristic of the variable throttle As and the opening characteristic of the variable throttle Ab of the flow control valve 4 during regeneration is substantially the same as the opening characteristic of the variable throttle As during non-regeneration, so that the variable throttle Ax of the regenerative variable switching valve 9 may be omitted.

In addition, the regenerative variable switching valve 9 has been described as an electromagnetic proportional throttle valve including the variable throttle Ab and the variable throttle Ax, but is not limited thereto, and may be, for example, a hydraulic flow control valve that is controlled by pilot secondary pressure.

In addition, the flow control valve 4 is not limited to being configured to be operated by hydraulic pressure, and may be an electromagnetic proportional throttle valve.

In addition, in the above-described embodiments, the oil has been described as an example of the fluid of the fluid pressure circuit; however, it goes without saying that the present invention can be applied to all fluids such as water or air. Further, the fluid pressure accumulator that pressurizes the fluid in the tank is not limited to the hydraulic pump, and can be changed in various forms depending on the fluid used in the fluid pressure circuit, and may be, for example, an air cylinder, an accumulator, or the like.

In addition, in the above-described embodiments, a case where the regenerative variable switching valve 9 is switched from the regeneration position to the non-regeneration position from a regenerative state where the return fluid is branched off and supplied to the pressure booster 61 or the regenerative motor 10 has been mainly described as an example; however, the present invention is not limited thereto, and it goes without saying that the hydraulic circuit of the present invention can suppress a sudden change in the rod speed of the hydraulic cylinder 5 and smoothly control the rod 5a even when the regenerative variable switching valve 9 is switched from the non-regeneration position to the regeneration position.

### REFERENCE SIGNS LIST

1 Drive mechanism
2 Main hydraulic pump
3 Pilot hydraulic pump
4 Flow control valve (operation switching valve)
5 Hydraulic cylinder (cylinder device)
5a Rod
8 Tank
9 Regenerative variable switching valve (flow diverter valve)
10 Regenerative motor
11 Generator
12 Remote control valve
12a Operating lever
13 Pressure sensor
14 Controller
15 to 30 Oil passage
33 Oil passage
40 Wheel loader
52 Hydraulic circuit
60 Accumulator (storage device)
61 Pressure booster
62 Storage detector
63 Pressure sensor (detection device)
72 Hydraulic circuit
73 Electricity storage device (storage device)
74 Storage detector

1. A fluid pressure circuit, comprising:
a cylinder device;
an operation switching valve; and
a regenerative circuit that branches off from a flow passage between the cylinder device and the operation switching valve via a flow diverter valve,
wherein a detection device configured to detect discharge information is disposed between the cylinder device and the flow diverter valve, and
the flow diverter valve is configured to be controlled based on the discharge information detected by the detection device and information obtained from the regenerative circuit.

2. The fluid pressure circuit according to claim 1,
wherein the regenerative circuit includes a storage device, and the flow diverter valve is configured to be controlled based on a signal from a storage detection device that detects a storage state of the storage device, and on the discharge information from the detection device.

3. The fluid pressure circuit according to claim 1,
wherein a first throttle provided in the flow passage between the cylinder device and the operation switching valve and a second throttle provided in the flow diverter valve are configured to be controlled by functions with different positive and negative slopes.

4. The fluid pressure circuit according to claim 3,
wherein the flow diverter valve is a 3-port, 2-position electromagnetic proportional throttle valve of normal-open type that is configured to simultaneously control opening degrees of the first throttle and the second throttle.
